(19) United States
(12) Patent Application Publication
(10) Pub. No.: US 2026/0299473 A1
(43) Pub. Date: Oct. 1, 2026

(54) FIXING DEVICE AND IMAGE FORMING SYSTEM

(71) Applicant: FUJIFILM Business Innovation Corp., Tokyo (JP)

(72) Inventor: Daisuke KUWABARA, Kanagawa (JP)

(73) Assignee: FUJIFILM Business Innovation Corp., Tokyo (JP)

(21) Appl. No.: 19/283,249

(22) Filed: Jul. 29, 2025

(30) Foreign Application Priority Data
Mar. 25, 2025 (JP) 2025-050683

(51) Int. Cl. G03G 15/20; G03G 15/00

(52) U.S. Cl. CPC G03G 15/2064; G03G 15/2021; G03G 15/6585; G03G 2215/00413; G03G 2215/00679; G03G 2215/00708; G03G 2215/00805; G03G 2215/00814

(57) ABSTRACT

A fixing device includes: a transport belt configured to transport a recording medium; and a first fixing unit configured to perform pressurization and heating on the recording medium transported onto the transport belt, and perform fixing processing of an image formed on the recording medium, in which, in a case where a recording medium on which the fixing processing is not performed is transported, the first fixing unit performs the pressurization on the recording medium at a distal end portion in a transport direction of the recording medium and releases the pressurization on the recording medium in a region of the recording medium except for the distal end portion.

### CROSS-REFERENCE TO RELATED APPLICATIONS

This application is based on and claims priority under 35 USC 119 from Japanese Patent Application No. 2025-050683 filed Mar. 25, 2025.

### BACKGROUND

### (i) Technical Field

The present disclosure relates to a fixing device and an image forming system.

### (ii) Related Art

JP2005-262810A discloses a cutting device capable of stably discharging a cut recording sheet.

JP2005-114832A discloses an image forming device capable of efficiently forming an image on both surfaces of a recording medium.

JP2011-085861A discloses an image forming device that prevents a problem in which damage or the like occurs in a roll made of an elastic body in a case where very thick paper having a thickness of 0.4 mm or more is used in a secondary transfer unit or a fixing unit.

### SUMMARY

A fixing device that performs fixing processing on an image formed on a recording medium by transporting the recording medium that is transported onto a transport belt in a state of being pressurized and heated has been proposed.

In such a fixing device, in a case where a recording medium on which the fixing processing is not performed is transported in a pressurized state without being heated, toner or ink forming an image on the recording medium adheres to the transport belt, which causes contamination of the transport belt.

Aspects of non-limiting embodiments of the present disclosure relate to a fixing device and an image forming system capable of reducing contamination of a transport belt in a case where a recording medium on which fixing processing is not performed is transported, as compared with a case where an entirety of the recording medium is pressurized.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a fixing device including: a transport belt configured to transport a recording medium; and a first fixing unit configured to perform pressurization and heating on the recording medium transported onto the transport belt, and perform fixing processing of an image formed on the recording medium, in which, in a case where a recording medium on which the fixing processing is not performed is transported, the first fixing unit performs the pressurization on the recording medium at a distal end portion in a transport direction of the recording medium and releases the pressurization on the recording medium in a region of the recording medium except for the distal end portion.

### BRIEF DESCRIPTION OF THE DRAWINGS

Exemplary embodiment(s) of the present invention will be described in detail based on the following figures, wherein:

FIG. 1 is a schematic configuration diagram of an image forming system according to an exemplary embodiment of the present disclosure;

FIG. 2 is a block diagram showing a hardware configuration of a control unit in a secondary fixing device;

FIG. 3 is a schematic configuration diagram of a fixation unit in the secondary fixing device;

FIG. 4 is a diagram showing a state in which pressurization is performed on a recording medium in the fixation unit;

FIG. 5 is a diagram showing a state in which the pressurization is released on the recording medium in the fixation unit; and

FIG. 6 is a diagram for describing the recording medium.

### DETAILED DESCRIPTION

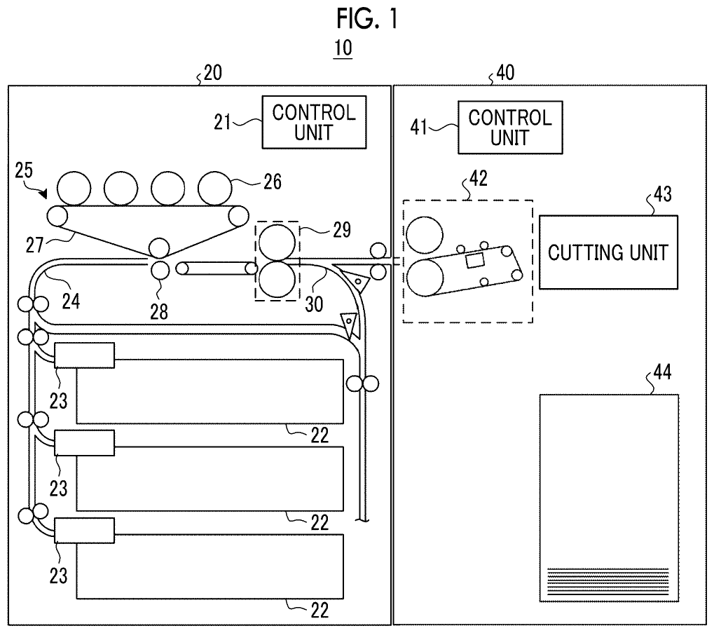

Hereinafter, an exemplary embodiment of the present disclosure will be described in detail with reference to the drawings. FIG. 1 is a schematic configuration diagram of an image forming system 10 according to an exemplary embodiment of the present disclosure.

As shown in FIG. 1, the image forming system 10 of the present exemplary embodiment is constituted by an image forming device 20 and a secondary fixing device 40. The image forming device 20 is a device for forming an image on a recording medium. In addition, the secondary fixing device 40 is an external device that further performs fixing processing on the recording medium output from the image forming device 20 to increase an amount of gloss of the image.

The image forming device 20 includes three recording medium supply cassettes 22. A supply head 23 is provided in each of the recording medium supply cassettes 22. In a case where one of the recording medium supply cassettes 22 is selected, the supply head 23 is operated. Then, the recording medium is supplied from the selected recording medium supply cassette 22 to an image forming unit 25 via a recording medium supply path 24.

In the image forming unit 25, photosensitive bodies 26 for colors, which are yellow, magenta, cyan, and black, are arranged side by side, and an intermediate transfer belt 27 is provided. A charging device, an exposure device, a developing device, a primary transfer device, a cleaning device, and the like (not shown) are disposed around each photosensitive body 26, and a toner image formed on each photosensitive body 26 is transferred to the intermediate transfer belt 27. In a case where the image forming color is set to black and white, only the photosensitive body 26 for black is operable.

The toner image on the intermediate transfer belt 27 is transferred to the recording medium as an image by a secondary transfer roll 28 and is fixed to the recording medium by a fixing unit 29. The fixing unit 29 is an example of a second fixing unit in the technology of the present disclosure. Then, the recording medium on which the image is fixed is discharged to an outside through a recording medium discharge path 30.

The fixing unit 29 includes a pressurizing roll and a heating processing unit. The pressurizing roll is heated by a heating processing unit, and the image is fixed to the recording medium by pressurizing and heating the image formed on the recording medium.

In addition, the image forming device 20 includes a control unit 21. The control unit 21 controls an operation of an entirety of the image forming device 20 and executes processing of forming an image on the recording medium.

The secondary fixing device 40 is an optional device for increasing the amount of gloss of the image by further performing fixing processing on the image on the recording medium discharged from the image forming device 20.

As shown in FIG. 1, the secondary fixing device 40 includes a control unit 41, a fixation unit 42, a cutting unit 43, and an accommodation unit 44. The fixation unit 42 is an example of a fixing device in the technology of the present disclosure.

The control unit 41 controls an operation of an entirety of the secondary fixing device 40 and communicates with the control unit 21 of the image forming device 20 to obtain information on an operating state of the image forming device 20. Accordingly, the control unit 41 executes further fixing processing on the recording medium discharged from the image forming device 20 by means of the fixation unit 42, sends the recording medium after the fixing processing to the cutting unit 43 to cut the recording medium, and then accommodates the recording medium in the accommodation unit 44.

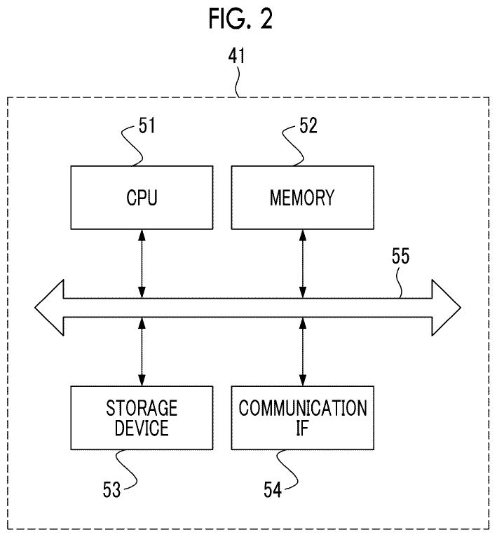

Next, a configuration of the control unit 41 in the secondary fixing device 40 of the present exemplary embodiment will be described. FIG. 2 is a block diagram illustrating a hardware configuration of the control unit 41.

As shown in FIG. 2, the control unit 41 includes a central processing unit (CPU) 51, a memory 52, a storage device 53 such as a hard disk drive, and a communication interface (abbreviated as a communication IF in FIG. 2) 54 that transmits and receives data with an external device or the like. The components are connected to each other via a control bus 55.

The CPU 51 is a processor that executes predetermined processing based on a control program stored in the memory 52 or the storage device 53 to control the operation of the secondary fixing device 40. In the present exemplary embodiment, a configuration in which the CPU 51 reads the control program stored in the memory 52 or the storage device 53 and executes the control program is described, but the present disclosure is not limited thereto. The control program may be provided in a form recorded on a computer-readable recording medium. For example, the program may be provided in a form of being recorded on an optical disc such as a compact disc (CD)-read only memory (ROM) and a digital versatile disc (DVD)-ROM, or in a form of being recorded on a semiconductor memory such as a universal serial bus (USB) memory and a memory card. Further, the control program may be acquired from an external apparatus via a communication line connected to the communication interface 54. Further, the control program may be provided, for example, as single application software or may be incorporated, as one function of the secondary fixing device 40, in software of each device.

The control unit 41 configured as described above controls the operation of the fixation unit 42 or the like, and thus secondary fixing processing is executed on the image formed on the recording medium.

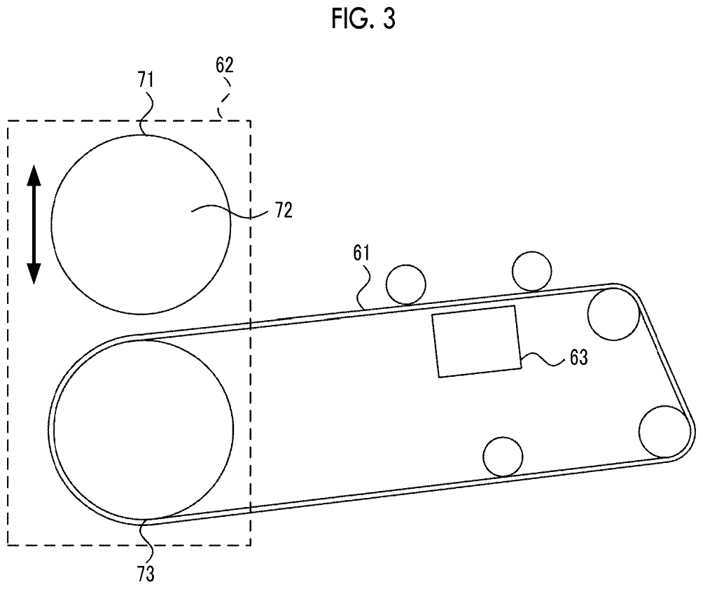

Next, a configuration of the fixation unit 42 in the secondary fixing device 40 of the present exemplary embodiment will be described. FIG. 3 is a schematic configuration diagram of the fixation unit 42.

As shown in FIG. 3, the fixation unit 42 includes a transport belt 61 that transports the recording medium, a fixing unit 62 that performs fixing processing on an image formed on the recording medium by performing pressurization and heating on the recording medium transported onto the transport belt 61, and a cooling unit 63 that cools the heated recording medium. The fixing unit 62 is an example of a first fixing unit in the technology of the present disclosure.

The fixing unit 62 includes a pressurizing roll 71, a heating processing unit 72 incorporated in the pressurizing roll 71, and a roll 73 disposed at a position facing the pressurizing roll 71 with the transport belt 61 interposed therebetween. The pressurizing roll 71 is configured to be move between a position where the pressurization is performed on the recording medium and a position where the pressurization is released.

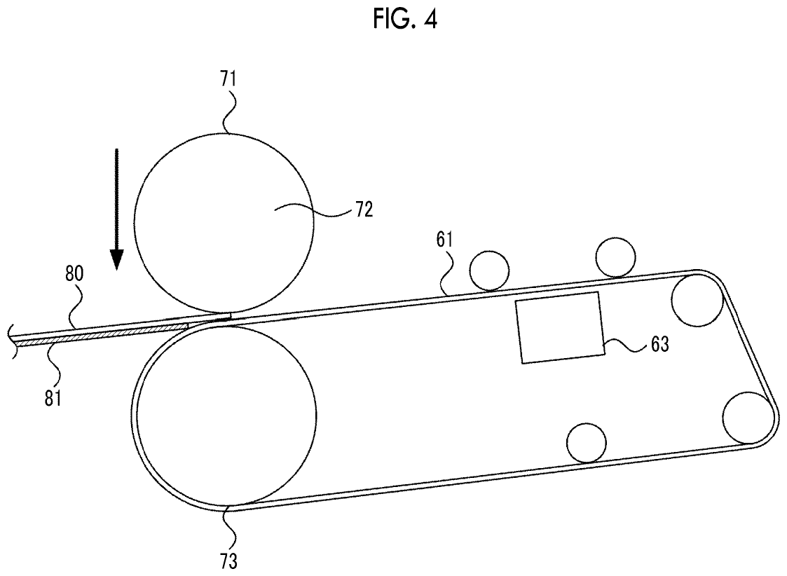

In a case where the fixing processing is performed in the fixing unit 62, the pressurizing roll 71 is moved to a position where the pressurization is performed on the recording medium 80, and is heated by the heating processing unit 72 as shown in FIG. 4. The fixing unit 62 performs fixing processing of imparting gloss to an image 81 fixed to the recording medium 80 by performing the pressurization and heating on the image 81 formed on the recording medium 80.

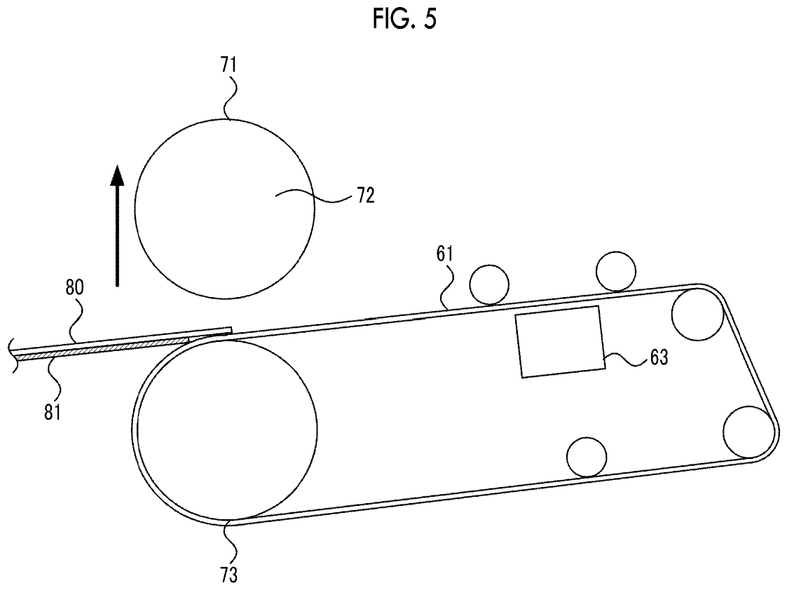

In a case where the fixing processing is not performed in the fixing unit 62, the pressurizing roll 71 is moved to a position where the pressurization on the recording medium 80 is released as shown in FIG. 5.

The secondary fixing device 40 may send the recording medium discharged from the image forming device 20 to the cutting unit 43 after performing the fixing processing in the fixation unit 42, or may send the recording medium to the cutting unit 43 without performing the fixing processing in the fixation unit 42.

Even in a case where the fixing processing is not performed, the pressurization needs to be performed on at least a part of the recording medium 80 against the transport belt 61 to closely attach the recording medium 80 to the transport belt 61 in order to transport the recording medium 80 with the transport belt 61.

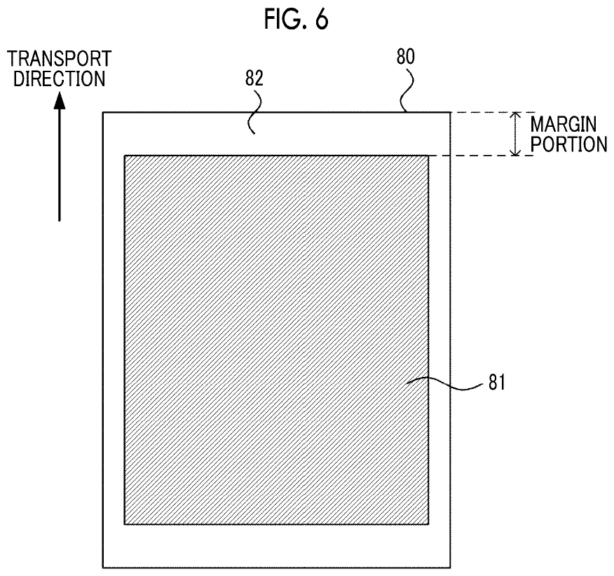

Therefore, in the fixation unit 42 of the present exemplary embodiment, in a case where the recording medium 80 on which the fixing processing is not performed is transported, the fixing unit 62 performs the pressurization on the recording medium 80 at a distal end portion 82 of the recording medium 80 in a transport direction as shown in FIG. 6 and releases the pressurization on the recording medium 80 in a region of the recording medium 80 except for the distal end portion 82.

In a case where the recording medium 80 is transported on which the fixing processing is not performed, in a case where the recording medium 80 is transported by the transport belt 61 in a state where only the pressurization is performed without performing the heating on the image 81 formed on the recording medium 80, the toner constituting the image 81 formed on the recording medium 80 may adhere to the transport belt 61, and the transport belt 61 may be contaminated.

In the present exemplary embodiment, in a case where the recording medium 80 on which the fixing processing is not performed is transported, the fixing unit 62 pressurizes only the distal end portion 82 in the recording medium 80 in which the image 81 is not formed, and releases the pressurization in a region except for the distal end portion 82. Therefore, the contamination of the transport belt 61 is reduced as compared with a case where an entirety of the recording medium 80 is pressurized.

Here, the distal end portion 82 may be a margin portion provided on a distal end side of the recording medium 80 in the transport direction. The margin portion is a region in which the image 81 is not formed on the recording medium 80. In this case, the distal end portion 82 may be a region within 10 mm from a distal end of the recording medium 80 in the transport direction.

In addition, in a case where the recording medium 80 on which the fixing processing is not performed is transported, the fixing unit 62 may perform the pressurization and the heating on the recording medium 80 at the distal end portion 82 of the recording medium 80 and release the pressurization on the recording medium 80 in the region of the recording medium 80 except for the distal end portion 82.

In addition, in a case where the recording medium 80 on which the fixing processing is not performed is transported, the fixing unit 62 may not perform the heating on the recording medium 80.

In addition, the control unit 41 may issue a notification to prompt transporting of a cleaning medium for cleaning the transport belt 61 onto the transport belt 61 in a case where the number by which recording mediums 80 on which the fixing processing is not performed are transported exceeds a threshold value that is set. Here, the control unit 41 functions as a notification unit in the technology of the present disclosure.

The cleaning medium may be any medium such as nonwoven fabric as long as it is a medium for cleaning the transport belt 61.

In this case, the control unit 41 may set the threshold value in response to instruction input from the user.

### Modification Examples

Although the image forming system 10 of the exemplary embodiment of the present disclosure has been described above, the technology of the present disclosure is not limited to the above-described exemplary embodiment and can also be appropriately changed.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

In addition, in the technology of the present disclosure, the system includes both a system configured with a plurality of devices and a system configured with a single device.

In addition, the technology of the present disclosure can also be applied to a program and a program product.

### Supplementary Notes

Regarding the exemplary embodiments described above, the following supplementary notes are further disclosed.
(((1)))

A fixing device comprising:
a transport belt configured to transport a recording medium; and
a first fixing unit configured to perform pressurization and heating on the recording medium transported onto the transport belt, and perform fixing processing of an image formed on the recording medium,
wherein, in a case where a recording medium on which the fixing processing is not performed is transported, the first fixing unit performs the pressurization on the recording medium at a distal end portion in a transport direction of the recording medium and releases the pressurization on the recording medium in a region of the recording medium except for the distal end portion.
(((2)))

The fixing device according to (((1))),
wherein the distal end portion is a margin portion provided on a distal end side of the recording medium in the transport direction.
(((3)))

The fixing device according to (((2))),
wherein the distal end portion is a region within 10 mm from a distal end of the recording medium in the transport direction.
(((4)))

The fixing device according to (((2))) or (((3))),
wherein, in a case where the recording medium on which the fixing processing is not performed is transported, the first fixing unit performs the pressurization and the heating on the recording medium at the distal end portion of the recording medium and releases the pressurization on the recording medium in the region of the recording medium except for the distal end portion.
(((5)))

The fixing device according to any one of (((1))) to (((3))),
wherein, in a case where the recording medium on which the fixing processing is not performed is transported, the first fixing unit does not perform the heating on the recording medium.
(((6)))

The fixing device according to any one of (((1))) to (((5))), further comprising:
a notification unit configured to issue a notification to prompt transporting of a cleaning medium for cleaning the transport belt onto the transport belt in a case where the number by which recording mediums on which the fixing processing is not performed are transported exceeds a threshold value that is set.
(((7)))

The fixing device according to (((6))),
wherein the notification unit sets the threshold value in response to instruction input from a user.
(((8)))

The fixing device according to any one of (((1))) to (((7))), further comprising:
a second fixing unit configured to perform the fixing processing of the image formed on the recording medium, upstream of the first fixing unit in the transport direction of the recording medium.
(((9)))

The fixing device according to (((8))),
wherein the first fixing unit performs fixing processing for imparting gloss, on an image fixed onto the recording medium by the second fixing unit.
(((10)))

An image forming system comprising:
an image forming device configured to form an image on a recording medium; and
the fixing device according to any one of (((1))) to (((9))), the fixing device being for performing the fixing processing on the recording medium output from the image forming device.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a transport belt configured to transport a recording medium; and
a first fixing unit configured to perform pressurization and heating on the recording medium transported onto the transport belt, and perform fixing processing of an image formed on the recording medium,
wherein, in a case where a recording medium on which the fixing processing is not performed is transported, the first fixing unit performs the pressurization on the recording medium at a distal end portion in a transport direction of the recording medium and releases the pressurization on the recording medium in a region of the recording medium except for the distal end portion.

2. The fixing device according to claim 1,
wherein the distal end portion is a margin portion provided on a distal end side of the recording medium in the transport direction.

3. The fixing device according to claim 2,
wherein the distal end portion is a region within 10 mm from a distal end of the recording medium in the transport direction.

4. The fixing device according to claim 2,
wherein, in a case where the recording medium on which the fixing processing is not performed is transported, the first fixing unit performs the pressurization and the heating on the recording medium at the distal end portion of the recording medium and releases the pressurization on the recording medium in the region of the recording medium except for the distal end portion.

5. The fixing device according to claim 1,
wherein, in a case where the recording medium on which the fixing processing is not performed is transported, the first fixing unit does not perform the heating on the recording medium.

6. The fixing device according to claim 1, further comprising:
a notification unit configured to issue a notification to prompt transporting of a cleaning medium for cleaning the transport belt onto the transport belt in a case where the number by which recording mediums on which the fixing processing is not performed are transported exceeds a threshold value that is set.

7. The fixing device according to claim 6,
wherein the notification unit sets the threshold value in response to instruction input from a user.

8. The fixing device according to claim 1, further comprising:
a second fixing unit configured to perform the fixing processing of the image formed on the recording medium, upstream of the first fixing unit in the transport direction of the recording medium.

9. The fixing device according to claim 8,
wherein the first fixing unit performs fixing processing for imparting gloss, on an image fixed onto the recording medium by the second fixing unit.

10. An image forming system comprising:
an image forming device configured to form an image on a recording medium; and
the fixing device according to claim 1, the fixing device being for performing the fixing processing on the recording medium output from the image forming device.

11. An image forming system comprising:
an image forming device configured to form an image on a recording medium; and
the fixing device according to claim 2, the fixing device being for performing the fixing processing on the recording medium output from the image forming device.

12. An image forming system comprising:
an image forming device configured to form an image on a recording medium; and
the fixing device according to claim 3, the fixing device being for performing the fixing processing on the recording medium output from the image forming device.

13. An image forming system comprising:
an image forming device configured to form an image on a recording medium; and
the fixing device according to claim 4, the fixing device being for performing the fixing processing on the recording medium output from the image forming device.

14. An image forming system comprising:
an image forming device configured to form an image on a recording medium; and
the fixing device according to claim 5, the fixing device being for performing the fixing processing on the recording medium output from the image forming device.

15. An image forming system comprising:
an image forming device configured to form an image on a recording medium; and
the fixing device according to claim 6, the fixing device being for performing the fixing processing on the recording medium output from the image forming device.

16. An image forming system comprising:
an image forming device configured to form an image on a recording medium; and
the fixing device according to claim 7, the fixing device being for performing the fixing processing on the recording medium output from the image forming device.

17. An image forming system comprising:
an image forming device configured to form an image on a recording medium; and
the fixing device according to claim 8, the fixing device being for performing the fixing processing on the recording medium output from the image forming device.

18. An image forming system comprising:
an image forming device configured to form an image on a recording medium; and
the fixing device according to claim 9, the fixing device being for performing the fixing processing on the recording medium output from the image forming device.
